(19) United States
(12) Patent Application Publication
(10) Pub. No.: US 2014/0266559 A1
(43) Pub. Date: Sep. 18, 2014

(54) STRUCTURE OF TRANSFORMER'S IRON CORE

(71) Applicant: Sen-Tai Yang, New Taipei City (TW)

(72) Inventor: Sen-Tai Yang, New Taipei City (TW)

(73) Assignee: YUJING TECHNOLOGY CO., LTD., New Taipei City (TW)

(21) Appl. No.: 14/206,211

(22) Filed: Mar. 12, 2014

(30) Foreign Application Priority Data
Mar. 13, 2013 (TW) 102108771

(51) Int. Cl. H01F 3/08

(52) U.S. Cl. CPC H01F 3/08
USPC 336/233

(57) ABSTRACT

An improved structure of transformer's iron core mainly has an iron core main body, having a salient main core part with a rectangular horizontal cross-section, furnished at the center part thereof. The main core part has a pair of oppositely configured side wing parts furnished at the outside thereof. A containing circumferential channel formed between the main core part and the side wing parts has a pair of oppositely configured side openings making the containing circumferential channel form communicative exits toward the outside through the two side openings. By employing the salient main core part with a rectangular-shaped horizontal cross-section, the invention is capable of forming longer outer circumference to effectively increase the area of the magnetic flux thereof under the premise of same bobbin. Moreover, in association with the relatively larger side openings that are capable of providing lead frame containing in the containing ring-trench to be outwardly connected to a relatively wider wire connecting seats, the invention is capable of satisfying the required specification of multiple wire-drawing.

### BACKGROUND OF THE INVENTION

1. Field of the Invention

The invention relates to an improved structure of transformer's iron core, and more particularly, to an improved structure of transformer's iron core having both relatively larger side-opening and relatively larger magnetic flux area generated between each of the windings.

2. Description of the Prior Art

FIG. 1 is an isometric exploded view of the structure of the transformer of the prior art while FIG. 2 is an isometric view of the assembled structure of the transformer of the prior art. As shown in FIG. 1 and FIG. 2, the most widespread application of transformer's iron core and its related components mainly include a lead frame (8), two iron cores (9) having one of them at the top while the other one of them at the bottom, and coil (821). The lead frame (8) has a central hole (81) furnished at the center thereof. A bobbin (82) provided, to be wound by a coil (821) which includes a primary winding, a secondary winding, as well as a control winding in accordance with its necessity is furnished at the periphery of the central hole (81). Moreover, extension parts (83), (831) which are connected to the central section of wire connecting seats (84), (841) respectively are furnished on each side of the central hole (81). What is more, wire connecting posts (85), (851) which pull out each of the drawing heads of the coil (821) are furnished, at the wire connecting seats (84), (841).

The iron core (9) has a round-shaped main core part (91) furnished at the center thereof. A containing ring-trench (93) having two oppositely configured and outward communicative side openings (94), (941) provided at the periphery thereof is furnished at the periphery of the main core part (91) making the rest parts of the periphery of the containing ring-trench (93) form two oppositely configured side parts (92).

When it comes to assembling, one has the main core parts (91) of the top and bottom iron cores (9) contact each other by stretching them through the central hole (81) of the lead frame (8) which is contained by the containing ring-trench (93) in the same time, in the mean time, the extension parts (83), (831) are stretched out through the side openings (94), (941) of the contacted top and bottom iron cores (9) making the wire connecting seats (84), (841) and wire connecting posts (85), (851) keep in the outer position of the iron core (9). A magnetic loop is capable of being formed at the periphery of the coil (821) of the bobbin (82) by having the side parts (92) of the iron core (9) in association with main core part (91).

Since the above-mentioned structure has relatively wider side openings (94), (941), the lead frame (8) is capable of further containing relatively more outward wire connecting posts (85), (851) through the side openings (94), (941). Therefore, this kind of structure is capable of satisfying the requirements of the transformer's specification having relatively more sets of drawing head. However, since the main core part (91) having circular transverse cross-section has relatively shorter transverse circumferential length making the limited corresponding area between the main core part (91) and the circumferentially wound coil (821). As a result, besides being relatively smaller in magnetic flux area, due to the increase of the transverse magnetic flux length that results in increase of magnetic reluctance and magnetic leakage, and consequently affecting the overall transferring efficiency of power source.

Following the progress in material and machining technologies, and for the sake of satisfying the product requirements of large current and small geometry, it becomes popular by employing metal strips as transformer windings. FIG. 3 is an isometric exploded view of the structure of the transformer employing metal strip as secondary winding of the prior art, and FIG. 4 is an isometric view of the assembled structure of the transformer of FIG. 3 of the prior art. As shown in FIG. 3, and FIG. 4, the structure of the transformer mainly includes a lead frame (5), a pair of oppositely configured and to-be-combined iron cores (7), as well as a plurality of metal strips (6). The pair of iron cores (7) has a main core part (71) and a plurality of side parts (72) furnished at the center and sides respectively thereof where a containing space (73) formed between them for containing the lead frame (5) which is slipped on through a through hole (51) furnished at the center thereof is communicative outward through recesses (74) formed between the side parts (72). A pair of positioning parts (531) are defined through a pair of partition plates (53) furnished on the top and bottom sides of a bobbin (55) provided for being wound by a primary winding (52) (coil). Each of the pair of partition plates (53) has a wire-connecting seat (54) furnished at each corner thereof by stretching through the recess (74) where the wire-connecting seat (54) has at least a wire-connecting post (541) connected to both ends of the primary winding (52). Each of the metal strips (6) having center holes (61) for slipping on the pair of positioning parts (531) on the top and bottom of the bobbin (55) has a partitioning slot (62) furnished at the corner thereof and communicative outward making each of the metal strips (6) form a pair of separated pole legs (63) which are stretched out of the iron core (7) through the recesses (74). When it comes to assembling, each of the metal strips (6) is capable of forming a secondary winging after insulated partitioning strips (64) are furnished between thereof having all of the strips (6) stack up in a manner that the strips (6) are perpendicular to the extended direction of the main core part (71) of the iron core (7). Further more, when it comes to practical application, since the metal strips (6) are perpendicular to the magnitude flux of the main core parts (71), the penetrating area of the magnitude reluctance will be increased. Although Eddy current loss can be lower in a small content by employing multiple layers of stacked-up metal strips (6), the thickness of the metal strip (6) still needs to be rigorously controlled making the assembling work difficult and the cost higher.

The iron core (7) of the above-mentioned structure having rectangular-shaped main core part (71) is capable of increasing the corresponding contact area with the circumferential side of the primary winding (52), but since the structure is unable to overcome the technical limit of having the metal strips (6) install on the lead frame (5) making each of the metal strips (6) need to stack up in the direction perpendicular to the main core part (71) of the iron core (7). Consequently the structure has the following shortcomings in application:

1. The structure having relatively high magnetic leakage is unable to satisfy the user's requirement of having low magnetic leakage since each of the metal strips (6) and the main core parts (71) of the iron core (7) appear extended in perpendicular direction;

2. Since the pole legs (63) stretching out through the iron core (7) of the metal strips (6) appear extended in perpendicular direction with the main core part (71), therefore, after being assembled with the circuit board, the structure having the main core part (71) of iron core (7) appears extended in parallel direction with the circuit board is unable to satisfy the requirement of the specification having the main core part (71) of iron core (7) appears extended in perpendicular direction with the circuit board;

3. The recesses (74) furnished on the side of the side parts (72) of the iron core (7) for each of the wire connecting seats (54) to be outwardly connected to each of the polar legs (63). However, this kind of design sometimes is unable to satisfy the requirements for the transformer's specification having a multiple sets of wire drawing head since the iron core has at most four recesses (74) only.

Therefore, the structure of the iron core (7) having rectangular main core part (71) is still needed to be improved in practical application.

### SUMMARY OF THE INVENTION

In light of the above-mentioned disadvantages of the prior art, the invention provides an improved structure of transformer's iron core that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide an improved structure of transformer's iron core that is capable of forming longer outer circumference to effectively increase the area of the magnetic flux thereof under the premise of same bobbin.

The secondary objective of the invention is to provide an improved structure of transformer's iron core that is capable of providing lead frame containing in the containing ring-trench to be outwardly connected to a relatively wider wire connecting seats and satisfying the required specification of multiple wire-drawing.

To achieve the above-mentioned objectives and efficacies. An improved structure of transformer's iron core mainly has an iron core main body, having a salient main core part with a rectangular horizontal cross-section, furnished at the center part thereof. The main core part has a pair of oppositely configured side wing: parts furnished, at the outside thereof. A containing circumferential channel formed between the main, core part and the side wing parts has a pair of oppositely configured side openings making the containing circumferential channel form communicative exits toward the outside through the two side openings.

In accordance with the above-mentioned structure, the main, core part has a rectangular horizontal cross-section.

In accordance with the above-mentioned structure, the pair of side openings having, a width that is smaller than the inner side width between the two oppositely configured side wing parts making the two side wing parts possible to form an end salient part at both ends of the side wing parts respectively and each of the end salient parts shutters part of the area of the side openings respectively.

In accordance with the above-mentioned structure, fillets are furnished at each end corner of both the main core part and the containing circumferential channel.

In accordance with the above-mentioned structure, a pair of securing indented parts, furnished respectively on the opposite side of a side edge far away from the main core part, are provided to be stretched and clipped by the clip fasteners.

The accomplishment of this and other objectives of the invention will become apparent from the following description and its accompanying drawings of which:

### BRIEF DESCRIPTION OF THE DRAWINGS

FIG. 1 is an isometric exploded, view of the structure of the transformer of the prior art.

FIG. 2 is an isometric view of the assembled structure of the transformer of the prior art.

FIG. 3 is an isometric, exploded view of the structure of the transformer employing metal strip as secondary winding of the prior art.

FIG. 4 is an isometric view of the assembled structure of the transformer of FIG. 3 of the prior art.

FIG. 5 is an isometric exploded view of the structure of the transformer and its related embodied parts of the invention.

FIG. 6 is an isometric view of the assembled structure of the transformer and its related embodied parts of the invention.

### DETAILED DESCRIPTION OF THE PREFERRED EMBODIMENT

FIG. 5 is an isometric exploded view of the structure of the transformer and its related embodied parts of the invention and FIG. 6 is an isometric view of the assembled structure of the transformer and its related embodied parts of the invention. As shown in FIG. 5 and FIG. 6, the improved structure of transformer's iron core of the invention mainly includes two iron cores (I) each having a salient main core part (11) furnished at the center part thereof. The main core part (11) being a structure having a rectangular or rectangular horizontal cross-section has a pair of oppositely configured side wing parts (12) furnished at the outside thereof. A containing circumferential channel (13) formed between the main core part (11) and the side wing parts (12) has a pair of oppositely configured side openings (14), (15) making the containing circumferential channel (13) form communicative exits toward the outside through the two side openings (14), (15). Moreover, the pair of side openings (14), (15) having a width that is smaller than the inner side width between the two oppositely configured side wing parts (12) making the two side wing parts (12) possible to form an end salient part (121) at both ends of the side wing parts (12) respectively. Each of the end salient parts (121) shutters part of the area of the side openings (14), (15) respectively. What is more, there are fillets (111) furnished at each end corner of both the main core part (11) and the containing circumferential channel (13) to prevent the leather cover film of the iron core (1) from being scratched by the sharp ridges when it comes to coil-winding work. Besides, a pair of securing indented parts (16) is furnished respectively on the opposite side of a side edge far away from the main core part (11).

In an embodiment of the invention, the iron core (1) is a transformer structure composed by employing a trouser-like flap (3) as a winding capable of accommodating with a lead frame module (2) which is consisted of a lead frame main body (21) and a lead frame cover (22). The lead frame main body (21) being a pipe body made of plastics has a penetration hole (211) provided at the center thereof. A bobbin (212) is formed at the periphery of the penetration hole (211). Two oppositely configured wire connecting seats (213), (214) are provided at both ends of the lead frame main body (21) where the wire connecting seat (213) has a plurality of primary winding conducting posts (2131) furnished thereof where the wire connecting seat (214) has a plurality of spare conducting posts (2143) and two indented openings (2141), (2142). Besides, a pair of oppositely configured hook parts (215) is furnished at the ends of the penetration hole (211).

The lead frame cover (2.2) being a plate body made of plastics has a through hole (221) furnished at the center thereof. The through hole (221) being corresponding to the penetration hole (211) has the same size as the penetration hole (211). At least two to-be-hooked parts (222) corresponding to a pair of hook parts (215) are provided at the inner rim of the circumference of the through hole (221). Moreover, a plurality of clip indentations (223), (224) are furnished in partition at the edges of the lead frame cover (22) corresponding to the wire connecting seats (213), (214).

The trouser-like flap (3) being made of metal has a waist part (31) which has a diameter slightly larger than that of the bobbin (212) is capable of slipping on the bobbin (212). The trouser-like flap (3) also includes thigh parts (32), (33) and wire-connecting legs (321), (331).

When it comes to assembling, firstly, one has the waist part (31) of the trouser-like flap (3) slip on the periphery of the bobbin (212) of the lead frame main body (21) making the wire-connecting legs (321), (331) pass through the two indented openings (2141), (2142) toward the extended directions of the spare conducting post (2143) and primary winding conducting posts (2131). Afterward, the lead flame cover (22) is covered on the side away from the wire connecting seats (213), (21.4) of the lead frame main body (21). By employing the combination between the hook parts (215) and the to-be-hooked parts (222), one is capable of making the lead frame cover (22) firmly combine with the lead frame main body (21), and in the mean time, prevent the trouser-like flap (3) from being come off to facilitate the winding around the outer circumference of the trouser-like flap (3) to form a primary winding by employing the enamel covered wire again. In addition, when it becomes necessary, one can wind at least another control winding to make the two end parts of the primary winding and the two end parts of the control winding to be embedded into various clip indentations (223), (224) to form temporary positioning. It is capable of having the two main core parts (11) of the two iron cores (1) stretch through the penetration hole (211) of the lead frame main body (21) to be contacted each other. What is more, the wire connecting seats (213), (214) of the lead frame main body (21) are also capable of stretching outward through the side openings (14), (15) respectively. Afterward, the two iron cores (1) are clipped firmly together respectively at the securing indented parts (16) by employing two clip fasteners (17). In addition, the clip fasteners (17) are capable of providing the iron cores (1) with earthing function that not only facilitates performing the earthing work but also effectively diminishes electromagnetic interference (EMI). Finally, the two end portions of the primary winding are brazed to connect at various spare conducting posts (2143) to accomplish the overall assembling work of the transformer.

As comparing with the main core part (91) having round horizontal cross section of the prior art, the above-mentioned iron core (1) structure with main core part (11) having the rectangular or square horizontal cross section of its main core part (11) structure of the invention is capable of forming longer outer circumference to effectively increase the area of the magnetic flux thereof under the premise of same bobbin. In the mean time the invention having the rectangular or square horizontal cross section of its main core part (11) furnished on the iron core (1) with a pair of relatively larger and oppositely configured side openings (14), (15) is the first time to be seen.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. An improved structure of transformer's iron core, comprising at least an iron core main body (1), having a salient main core part (11) with a rectangular horizontal cross-section, furnished, at the center part thereof; the main core part (11) has a pair of oppositely configured side wing parts (12) furnished at the outside thereof; a containing circumferential channel (13) formed between the main core part (11) and the side wing pans (12), has a pair of oppositely configured side openings (14), (15) making the containing circumferential channel (I) form communicative exits toward the outside through the two side openings (14), (15).

2. The improved structure of transformer's iron core as claimed in claim 1, wherein the main core part (11) has a square horizontal cross-section.

3. The improved structure of transformer's iron core as claimed in claim 1, wherein the pair of side openings (14), (15) have a width that is smaller than the inner side width between the two oppositely configured side wing parts (12) making the two side wing parts (12) possible to form an end salient part (121) at both ends of the side wing parts (12) respectively and each of the end salient parts (121) shutters part of the area of the side openings (14), (15) respectively.

4. The improved structure of transformer's iron core as claimed in claim 1, wherein fillets (111) are furnished at each end corner of both the main core part (11) and the containing circumferential channel (13).

5. The improved structure of transformer's iron core as claimed in claim 1, wherein a pair of securing indented parts (16), furnished respectively on the opposite side of a side edge far away from the main core part (11), are provided to be stretched and clipped by the clip fasteners (17).
